(19) United States
(12) Patent Application Publication
(10) Pub. No.: US 2024/0029122 A1
(43) Pub. Date: Jan. 25, 2024

(54) MISSED TARGET SCORE METRICS

(71) Applicant: Microsoft Technology Licensing, LLC, Redmond, WA (US)

(72) Inventor: Andrea HATEGAN, London (GB)

(21) Appl. No.: 17/871,398

(22) Filed: Jul. 22, 2022

(51) Int. Cl. G06Q 30/02; G06Q 10/06

(52) U.S. Cl. CPC G06Q 30/0282; G06Q 10/06395

(57) ABSTRACT

Missed target score (MTS) metrics can provide an understanding of the contribution of various factor values towards a difference in a desired target value and an observed value of the product. An MTS metric service can obtain user experience data, an overall observed average score from user feedback data and any associated text, and a predetermined target score. The MTS metric service can analyze the user experience data to determine factors and corresponding factor values and generate an MTS metric between the overall observed average score and the predetermined target score indicating an affect each corresponding factor value of a first factor has on the overall observed average score or an affect corresponding factor values of a second factor have on an individual missed target score of a corresponding factor value of a first factor. The MTS metric service can generate and provide a data visualization of the MTS metric.

### BACKGROUND

User experience data can be used to evaluate what users are saying about a product. User experience data refers to information collected from users regarding their experience using a product or service. User experience data can be obtained from many different channels and can come in a variety of different forms. For example, user experience data can include user feedback information and telemetry information. User feedback information can include information collected directly from users about their reactions to a product, service, or website experience. User feedback information can be collected from, for example, star ratings and reviews, customer satisfaction (CSAT) surveys, and Net Promoter Score (NPS) surveys.

Telemetry information can be collected to identify not only operations of a computing system, but also how certain software and software features are performing. Telemetry information can also be collected to identify how people interact with user interface (UI) and user experience (UX) designs. For example, telemetry systems associated with an e-commerce site can analyze server logs collected by the telemetry systems to determine how many people click on an item, how many people read the description, how many people added the item to their cart, and how many people completed the purchase.

User experience data plays an important role in the product design process. The insights provided by this user experience data can reveal areas of products that need to be improved. These insights can provide actionable insights to be used by developers to improve the product and overall customer experience through, for example, design changes and bug fixes.

### BRIEF SUMMARY

Techniques and systems for providing missed target score metrics are described. The described techniques and systems provide a metric that can quantify the experience of users when they are using a product. The described missed target score metric can help provide an understanding of the contribution of various factor values towards a difference in a desired target value and an observed value of the product.

A missed target score metric service can obtain user experience data of an application comprising an overall observed average score of the application from user feedback data and any text associated with the user feedback data and a predetermined target score for the application. The missed target score metric service can analyze the user experience data to determine factors and corresponding factor values including a first factor, each factor being an individual attribute of the user experience data; and generate a missed target score metric between the overall observed average score and the predetermined target score indicating an affect corresponding factor values of a second factor of the determined factors have on an individual missed target score for a corresponding factor value of the first factor of the determined factors. The missed target score metric service can generate and provide a data visualization of the missed target score metric.

The missed target score metric service can further generate a second missed target score metric between the overall observed average score and the predetermined target score indicating an affect each corresponding factor value of the first factor of the determined factors has on the overall observed average score, where the second missed target score metric is the individual missed target score for the corresponding factor value of the first factor of the determined factors.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 illustrates a snapshot of an example graphical user interface of an application distribution platform.

FIG. 2 illustrates an example conceptual diagram of techniques for providing missed target score metrics according to an embodiment of the invention.

FIG. 3 illustrates an example operating environment in which various embodiments of the invention may be practiced.

FIG. 4 illustrates an example process for providing missed target score metrics according to certain embodiments of the invention.

FIG. 5 illustrates an example data visualization of missed target score metrics according to certain embodiments of the invention.

FIG. 6 illustrates a snapshot of an example graphical user interface displaying a data visualization of a missed target score metric according to an embodiment of the invention.

FIGS. 7A and 7B illustrate snapshots of an example graphical user interface displaying data visualizations of a missed target score metric according to an embodiment of the invention.

FIG. 8 illustrates a snapshot of an example graphical user interface displaying a data visualization of a missed target score metric according to an embodiment of the invention.

FIG. 9 illustrates components of an example computing system that may be used to implement certain methods and services described herein.

### DETAILED DESCRIPTION

Techniques and systems for providing missed target score metrics are described. The described techniques and systems provide a metric that can quantify the experience of users when using a product. The described missed target score metric can help provide an understanding of the contribution of various factor values towards a difference in a desired target value and an observed value of the product.

Software developers can define measurable goals related to usability, performance, accessibility, practicality, and overall functionality of an application using set predetermined target scores for an application. In some cases, the predetermined target score can be a number set in an objectives and key results (OKR). An OKR includes an objective (a significant, concrete, clearly defined goal) and key results (measurable success criteria used to track the achievement of that goal). For example, a target score can be an OKR which states what the average score of the application should be in an app store.

Software developers can track the outcomes of the measurable goals using an average score of an application. An average score is an overall estimation of how happy users are with a product. If the average score is below the target score, software developers may want to know what is making the users unhappy. If developers understand what issues make the users unhappy, the developers can take action to resolve those issues.

If an observed average score is on target or above the target, meaning that the observed average score has about the same value as the target score or a higher score than the target score, software developers might think that users are happy enough with the application and changes do not need to be made. However, this is not always the case. Even if the observed average score is on target or above the target, there may be underlying issues with the application that need attention. Therefore, even if an application meets the target score overall, software developers want to understand which areas of the application are scoring above the target score and which areas of the application are scoring below the target score.

Stressors and delighters can cancel each other and mislead the developer to believe that users do not have any problems when using the application. For example, users may be very happy with a first aspect of the application and very unhappy with a second aspect of the application. In this case, the first aspect of the application would raise the average score of the application and the second aspect of the application would lower the average score of the application. Here, the first aspect and the second aspect could cancel each other out and the developer could miss identifying a problem with the application.

Typically, when gathering and analyzing user experience data (e.g., application reviews), only the score of the application or the number of reviews is considered. Indeed, the combination of the score and the proportion of reviews is not taken into account.

Unlike conventional approaches, the described missed target score metric is generated using both the probability and the average score of the user experience data. Advantageously, the missed target score metric can show which stressors and delighters are impacting the user experience score of an application. For example, a small group of strong stressors may contribute the same amount as a large group of mild stressors.

Using a single factor decomposition, the described missed target score metric provides an understanding of the contribution of various factor values towards pulling the observed average score up or down. A data visualization of the missed target score metric can reveal underlying issues with a software application or system and illustrate a level of pain for each issue related to the missed target score.

In addition to providing an understanding how the values of a given factor are pulling the average score up and down using the single factor decomposition, the missed target score metric can provide an understanding of how the values of a given factor are pulling the average score up and down in the context of another factor using two factor decomposition. Understanding how the values of a given factor are pulling the average score up and down in the context of another factor can deepen the understanding of user pain points and how to best address those pain points. For example, using a data visualization of the missed target score metric, a software developer can understand important questions such as, when users started talking about a topic and for how long they kept talking about it, which topics are activating for different languages, or if there is a topic that is activating only for a given manufacturer.

In an example scenario where an application has a predetermined target score (e.g., a desired OKR average rating) of 4.5 and an overall observed average score of 4.3, the application is missing the target score and has a missed target score of −0.2.

Advantageously, the missed target score metric can help developers of the application understand the contribution of various factor values towards having a missed target score of −0.2. The missed target score metric can help identify where the difference in the predetermined target score and the overall observed average score is coming from (e.g., what makes the difference exist) and, in the context of a given factor, which factor values contribute to missing the target.

For example, if the factor is “review language”, the factor values can include, for example, “English”, “Spanish”, “Chinese”, “French”, and “Dutch”. Using the single factor decomposition, the missed target score metric can indicate which languages contributed to missing the target. Here, an individual missed target score can be determined for each language (i.e., factor value).

The total missed target score for a factor is the sum of the individual missed target scores for all the factor values the factor can have. Here, the total missed target score for “review language” is the sum of the individual missed target score for “English”, the individual missed target score for “Spanish”, the individual missed target score for “Chinese”, the individual missed target score for “French”, and the individual missed target score for “Dutch”.

The contribution of each factor value (e.g., “English”, “Spanish”, “Chinese”, “French”, and “Dutch”) to the total missed target score is given by how likely that factor value is, and how far away the individual average score of the factor value is relative to the target score.

Using the two factor decomposition, an individual missed target score can be determined for each factor value of a given factor in the context of a second factor. Continuing with the previous example, a missed target score can be generated for each language of the first factor “review's language” given the Topic Cluster (second factor). This can allow a developer to see the review's language impact on each Topic Cluster. For the two factor decomposition, the observed average score is given by the average score of each individual factor value. In the previous example, each Topic Cluster has an average score and for each Topic Cluster, the impact of each language on the difference to the target score can be determined.

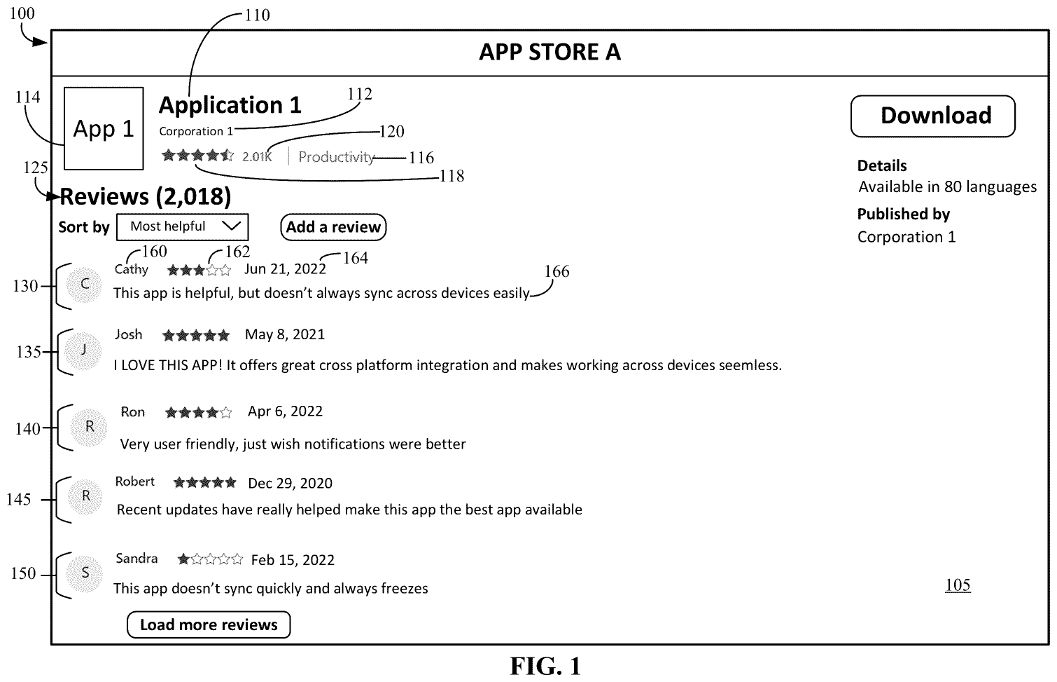

FIG. 1 illustrates a snapshot of an example graphical user interface of an application distribution platform. Application distribution platforms can implement an online store for purchasing and downloading software applications and/or components and add-ins for software applications. Examples of application distribution platforms include, but are not limited to, Google Play™ store from Google, Inc., App Store® from Apple, Inc., and Windows® Store from Microsoft Corp. An application distribution platform may be referred to as an “app store” or an “application marketplace”.

App stores can allow users to browse through a catalog of applications available for purchase and download and view information about each application. App stores typically provide a way for users to rate and review the applications they've downloaded through the app store. Ratings and reviews are useful for other app store users and developers. For example, users can select the best application based on the ratings and reviews; and developers can analyze the ratings and reviews to help understand how customers view their apps.

Referring to FIG. 1, a user may open a graphical user interface (GUI) 100 of an app store on their computing device. The computing device may be any computing device such as, but not limited to, a personal computer, a reader, a mobile device, a personal digital assistant, a wearable computer, a smart phone, a tablet, a laptop computer (notebook or netbook), a gaming device or console, an entertainment device, a hybrid computer, a desktop computer, a smart television, or an electronic whiteboard or large form-factor touchscreen.

Through the GUI 100, the user can view information about an application through a store listing for the application (e.g., store listing 105). In the illustrative example of FIG. 1, information included in the store listing 105 includes a title 110 of application, “Application 1”, a publisher 112 of the application, “Corporation 1”, an application icon 114 of the application, a category 116 of the application, “Productivity”, an overall average rating 118 of the application, and a total number of ratings 120 for the application, “2.01K”.

Store listing 105 also includes a reviews section 125 for the application. The reviews section 125 can include multiple reviews (review 130, review 135, review 140, review 145, and review 150); and each individual review displayed in the reviews section 125 can include a name of the reviewer, a rating, a date of the review, and any review content written by the reviewer.

In the illustrative example of FIG. 1, review 130 includes the name 160 of the reviewer, “Cathy”, the rating 162 that the reviewer gave the review 130 (three out of five stars), the date 164 the review 130, “Jun. 21, 2022”, and review content 166, “This app is helpful, but doesn't always sync across devices easily”.

Other information that may be associated with a review includes, but is not limited to, a country/region of the reviewer, a package version of the application on the reviewer's device at the time the review was left, an OS version of the device which the reviewer was using when the review was left, a manufacturer and type of the device which the reviewer was using when the review was left, and a language in which the review content was written.

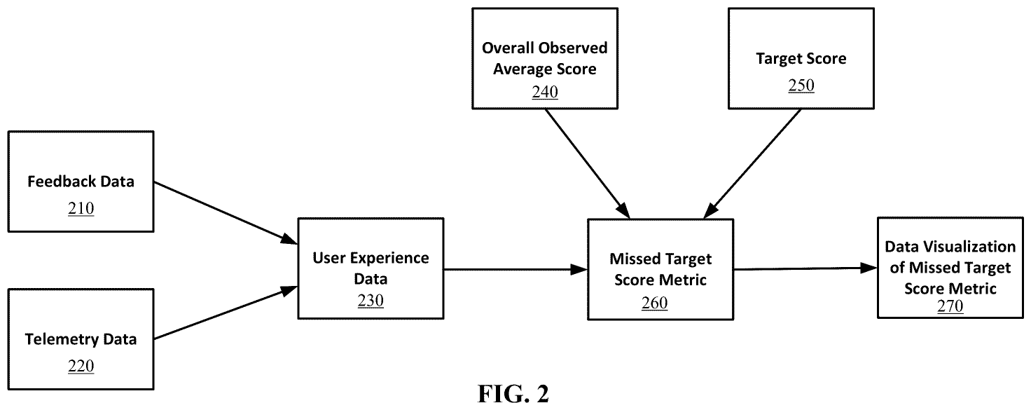

FIG. 2 illustrates an example conceptual diagram of techniques for providing missed target score metrics according to an embodiment of the invention. Referring to FIG. 2, user feedback data 210 of an application can be combined with telemetry data 220 from the application to generate user experience data 230 for the application.

The user feedback data 210 can include, but is not limited to, ratings and reviews, Net Promoter Score® (NPS), Customer Effort Score (CES), Customer Satisfaction (CSAT), and Goal Completion Rate (GCR).

Reviews are user comments written by a user who has purchased and used, or had experience with, the product or service and are usually accompanied by a rating (from 0 to 5). Written reviews allow users to share more detail about their experience with an application.

NPS indicates how likely a customer is to recommend a business to others (e.g., friends, family or colleagues). CES measures the amount of effort it took a user to deal with a product. CSAT measures how well a product meets the expectations of a customer. GCR measures the number of visitors who have completed, partly completed or failed to complete a specific goal on a product.

There are many different ways user feedback data 210 can be collected including, but not limited to, in person, via email, via the web, via phone calls, via in-product experiences (e.g., star ratings). Any of these techniques can be employed to obtain the user feedback data 210.

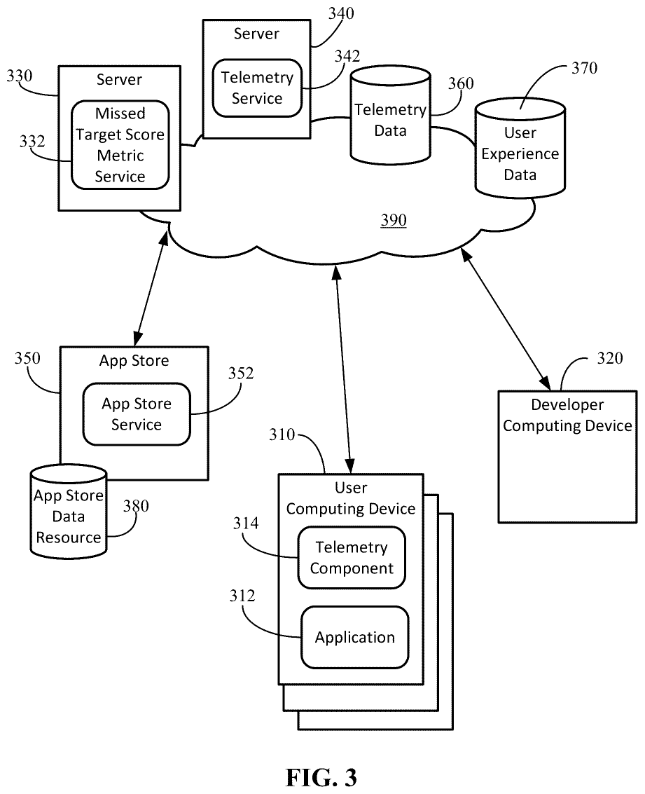

Telemetry data 220 can be collected to identify not only operations of a computing system, but also how certain software and software features are performing. Telemetry information can also be collected to identify how people interact with user interface (UI) and user experience (UX) designs. For example, telemetry systems associated with an e-commerce site can analyze server logs collected by the telemetry systems to determine how many people click on an item, how many people read the description, how many people added the item to their cart, and how many people completed the purchase. It should be understood that telemetry collection rules follow privacy protocols and permissions (set by the service, user, or client device) to restrict or narrow access to private information. A more detailed description of telemetry data will be provided in FIG. 3.

The user experience data 230 can include user experience data items. A user experience data item is a single unit of the user experience data 230. For example, a user experience data item can include a review from the user feedback data 210, a rating from the user feedback data 210, a usage data event from the telemetry data 220, or a diagnostic event from the telemetry data 220.

Each user experience data item of the user experience data 230 can have a set of factors and corresponding factor values. A factor refers to an individual attribute of the user experience data 230. In some cases, a factor is an attribute that each user experience data item readily has available in the app store data, such as, but not limited to manufacturer or review language. In some cases, a factor is inferred from text of the user experience data item, such as a topic cluster. A topic cluster refers to semantically similar data items.

Each factor can have an associated set of distinct factor values. For example, factor values for the manufacturer factor can include, but are not limited to, Huawei Technologies Co., Ltd. and Samsung Electronics Co., Ltd.; and factor values for the language factor can include, but are not limited to, English, Spanish, German, and Chinese.

The user experience data 230, an overall observed average score 240 of the application, and a predetermined target score 250 for the application can be used to generate a missed target score metric 260 for the application. The missed target score metric 260 can be generated between the overall observed average score 240 and the predetermined target score 250.

In some cases, the missed target score metric 260 can be generated using single factor decomposition. In this case, the missed target score metric 260 can indicate, in the context of one factor, the factor values that contributed to missing the target score. That is, for each distinct factor value of a factor, the missed target score metric 260 can indicate a net contribution of that factor value to pulling the observed average score 240 up or down.

In some cases, the missed target score metric 260 can be generated using two factor decomposition. In this case, the missed target score metric 260 can indicate an affect a corresponding factor value of a first factor has on the overall observed average score 240 in a context of a second factor of the determined factors. Indeed, the missed target score metric 260 can indicate how the factor values of the second factor are pulling up and down the individual missed target score of each individual factor value of the first factor.

A data visualization 270 of the missed target score metric 260 can be generated and presented to allow different stakeholders to independently explore the results. Advantageously, the missed target score metric 260 can provide an immediate understanding of where problems are located within the application and what aspects of the application are working well. The missed target score metric 260 can be used to determine any issues with the application that need immediate attention. These actionable insights allow software developers to prioritize any backlog and assess if problems have been solved.

In some cases, the data visualization 270 can be generated by sorting the factor values based on their net contribution to missing the target score to generate a ranked list of factor values. In some cases, the data visualization 270 can be generated by mapping factor values to a missed target score level. Each missed target score level can be assigned a distinct color. Each color can indicate, for example, how urgent an issue is or how painful the issue is for a user (e.g., the level of pain related to missing the target score).

FIG. 3 illustrates an example operating environment in which various embodiments of the invention may be practiced. Referring to FIG. 3, an example operating environment can include user computing devices, such as user computing device 310, a developer computing device 320, a server 330 implementing a missed target score (MTS) metric service 332, a server 340 implementing a telemetry service 342, an application distribution platform 350 implementing an app store service 352, and one or more data resources, such as telemetry data resource 360, user experience data resource 370, and application store data resource 380, each of which may store data sets.

User computing device (e.g., user computing device 310) may be a computing device such as, but not limited to, a personal computer, a reader, a mobile device, a personal digital assistant, a wearable computer, a smart phone, a tablet, a laptop computer (notebook or netbook), a gaming device or console, an entertainment device, a hybrid computer, a desktop computer, a smart television, or an electronic whiteboard or large form-factor touchscreen.

User computing device (e.g., user computing device 310) can run an application, such as application 312. Although reference is made to an “application”, it should be understood that the application, such as application 312 can have varying scope of functionality. That is, the application can be a stand-alone application or an add-in or feature of a stand-alone application.

User computing device (e.g., user computing device 310) can include a telemetry component 314 for assembling and sending telemetry messages to the telemetry service 342. As previously described, telemetry messages can include error logs, error information from debuggers, usage data, and performance data.

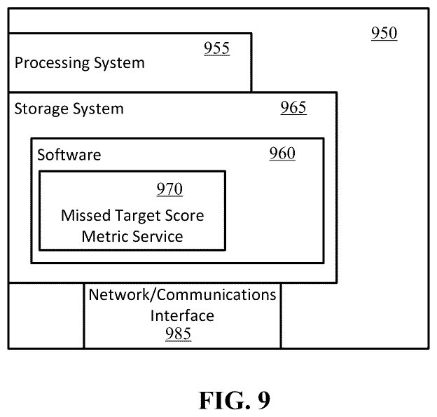

Telemetry service 342 may be implemented as software or hardware (or a combination thereof) on the server 340, which may be an instantiation of system 950 as described in FIG. 9. Telemetry data may be collected from telemetry messages received from multiple clients. Telemetry messages from user computing device 310 may be directed to telemetry service 342 via an application programming interface, or via another messaging protocol. A “telemetry message” is a signal from a client containing one or more kinds of telemetry data. Telemetry messages can include error logs, error information from debuggers, usage data logs, and performance data. A telemetry message contains an indicator of the source of the telemetry, identifying, for example, the device, user, application, component, license code, subdivision or category within an application or component, or other information that is the origin of the telemetry message.

A telemetry message also contains “state information,” or information about the conditions or circumstances surrounding, e.g., the error or usage data. The state information can vary widely by the type of telemetry message and the system, and holds information ranging from a simple numeric code to a detailed log of activities or events occurring at a point in time or over a time period. Some example types of telemetry message state include log data, event data, performance data, usage data, crash reports, bug reports, stack traces, register states, heap states, processor identifiers, thread identifiers, and application or component-level try/catch block exceptions. Telemetry message state can also include real-time performance information such as network load or processor load. It should be noted that these types of telemetry message states are merely exemplary and that any type of information that could be gathered from a device can potentially be contained in the telemetry message state, depending on the logging or telemetry capabilities of the device, application, or components. Naturally, a particular telemetry message's state information can include more than one type of state information.

In many cases a code or description, for example an error code or description, is included in the telemetry message that identifies the problem, event, or operation with a high degree of granularity. Sometimes, an error code or description is identified by the operating system, and sometimes an error code or description is specific to a particular application or component; in the latter case, a source identifier specifying the component may be required to discern the error condition. The code or description may be part of what is referred to herein as an “event identifier.”

It should be understood that telemetry collection rules follow privacy protocols and permissions (set by the service, user, or client device) to restrict or narrow access to private information.

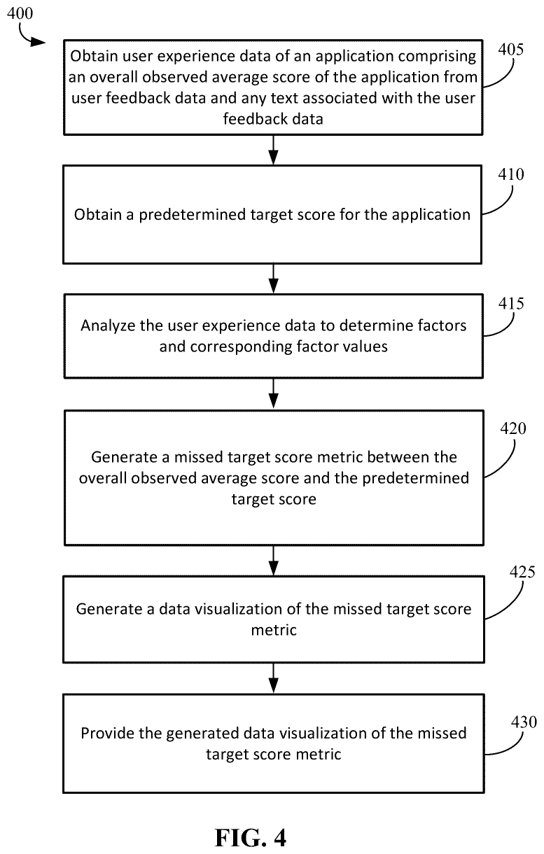

MTS metric service 332 may receive information, such as telemetry data from telemetry service 342. MTS metric service 332 can carry out processes, such as process 400 as described in FIG. 4. MTS metric service 332 may be implemented as software or hardware (or a combination thereof) on the server 330, which may be an instantiation of system 950 as described in FIG. 9. The information (e.g., events) received from the telemetry service 342 may be stored as telemetry data in a telemetry data resource 360.

User experience data resource 370, associated with server 330 or accessible through the cloud, may store user experience data as structured data. For example, the data set stored at the user experience data resource 370 may be populated with feedback data, such as feedback data 210 described with respect to FIG. 2, and telemetry data, such as telemetry data 220 described with respect to FIG. 2.

The information received, collected, and/or generated by the MTS metric service 332 (such as found in the application store data resource 380, the user experience data resource 370 and/or the telemetry data resource 360) may be stored on a same or different resource and even stored as part of a same data structure depending on implementation.

The MTS metric service 332 can be part of or communicate with an application distribution platform 350. As previously described, application distribution platforms can implement an online store for purchasing and downloading software applications and/or components and add-ins for software applications. Examples of application distribution platforms include, but are not limited to, Google Play™ store from Google, Inc., App Store® from Apple, Inc., and Windows® Store from Microsoft Corp. An application distribution platform may be referred to as an “app store” or an “application marketplace”.

A developer may have access to data generated by the MTS metric service 332, such as MTS metrics, through the developer computing device 320. Such data might be useful to developers for refining features or user interfaces. The data may also be useful to other parties, such as product designers and customer service representatives. The MTS metrics may be available through applications that can provide visual representations of the data (and enable exploration of the data). The developer computing device 320 may include the same type of device (or system) as user computing device 310.

Components (computing systems, storage resources, and the like) in the operating environment may operate on or in communication with each other over a network 390. The network 390 can be, but is not limited to, a cellular network (e.g., wireless phone), a point-to-point dial up connection, a satellite network, the Internet, a local area network (LAN), a wide area network (WAN), a WiFi network, an ad hoc network or a combination thereof. Such networks are widely used to connect various types of network elements, such as hubs, bridges, routers, switches, servers, and gateways. The network 390 may include one or more connected networks (e.g., a multi-network environment) including public networks, such as the Internet, and/or private networks such as a secure enterprise private network. Access to the network 390 may be provided via one or more wired or wireless access networks as will be understood by those skilled in the art.

As will also be appreciated by those skilled in the art, communication networks can take several different forms and can use several different communication protocols. Certain embodiments of the invention can be practiced in distributed-computing environments where tasks are performed by remote-processing devices that are linked through a network. In a distributed-computing environment, program modules can be located in both local and remote computer-readable storage media.

Communication to and from the components may be carried out, in some cases, via application programming interfaces (APIs). An API is an interface implemented by a program code component or hardware component (hereinafter “API-implementing component”) that allows a different program code component or hardware component (hereinafter “API-calling component”) to access and use one or more functions, methods, procedures, data structures, classes, and/or other services provided by the API-implementing component. An API can define one or more parameters that are passed between the API-calling component and the API-implementing component. The API is generally a set of programming instructions and standards for enabling two or more applications to communicate with each other and is commonly implemented over the Internet as a set of Hypertext Transfer Protocol (HTTP) request messages and a specified format or structure for response messages according to a REST (Representational state transfer) or SOAP (Simple Object Access Protocol) architecture.

FIG. 4 illustrates an example process for providing missed target score metrics according to certain embodiments of the invention. Referring to FIG. 4, a missed target score metric service performing one or more processes, such as process 400, can be implemented by a system such as described with respect to server 330 of FIG. 3, which can be embodied as described with respect to computing system 950 as shown in FIG. 9, and even, in whole or in part, by a user computing device.

The missed target score metric service can obtain (405) user experience data of an application. The user experience data can be obtained through a variety of channels and in a number of ways. For example, user feedback data of an application can be combined with telemetry data from the application to generate the user experience data for the application. The user feedback data can include, but is not limited to, ratings and reviews, Net Promoter Score® (NPS), Customer Effort Score (CES), Customer Satisfaction (CSAT), and Goal Completion Rate (GCR). Telemetry data can be collected to identify not only operations of a computing system, but also how certain software and software features are performing. It should be understood that telemetry collection rules follow privacy protocols and permissions (set by the service, user, or client device) to restrict or narrow access to private information.

The user experience data can include an overall observed average score of the application from the user feedback data and any text associated with the user feedback data.

The missed target score metric service can obtain (410) a predetermined target score for the application. As previously described, the target score can be a predetermined number set in an objectives and key results (OKR). An OKR includes an objective (a significant, concrete, clearly defined goal) and key results (measurable success criteria used to track the achievement of that goal). For example, a target score can be an OKR which states what the average score of the application should be in an app store.

In some cases, the predetermined target score for the application can be obtained with the user experience data. In some cases, the predetermined target score for the application can be obtained from an app store database, such as app store data resource 380 shown in FIG. 3.

The missed target score metric service can analyze (415) the user experience data to determine factors and corresponding factor values. As previously described, the user experience data can include user experience data items. A user experience data item is a single unit of the user experience data. For example, a user experience data item can include a review from the feedback data, a rating from the feedback data, a usage data event from the telemetry data, or a diagnostic event from the telemetry data.

Each user experience data item of the user experience data can have a set of factors and corresponding factor values. Each factor is an individual attribute of the user experience data. In some cases, a factor is an attribute that each user experience data item readily has available in the app store data, such as, but not limited to, a country/region of the reviewer, a package version of the application on the reviewer's device at the time the review was left, an OS version of the device which the reviewer was using when the review was left, a manufacturer and type of the device which the reviewer was using when the review was left, and a language in which the review content was written. manufacturer or review language. In some cases, a factor is inferred from text of the user experience data item, such as a topic cluster. A topic cluster refers to semantically similar data items.

Each factor can have an associated set of distinct factor values. For example, factor values for the manufacturer factor can include, but are not limited to, Huawei Technologies Co., Ltd. and Samsung Electronics Co., Ltd.; and factor values for the language factor can include, but are not limited to, English, Spanish, German, and Chinese.

In some cases, analyzing the user experience data to determine the factors and corresponding factor values includes extracting keywords from the user experience data; and inferring topic clusters from the text associated with the user feedback.

As an example, text from each user experience data item (e.g., review) is mapped to a high dimensional vector representation using Sentence Transformers, and relevant keywords are extracted from each user experience data item. Topic cluster estimation can then be performed where the high dimensional vector representations of the user experience data item are first projected to a lower dimensional space using UMAP, then clustered using HDBSCAN, and finally, the most representative keywords in each topic cluster represent the estimated topic for each topic cluster. The topic clusters can be automatically labeled.

In some cases, any user experience data items (e.g., reviews) that are not written in English are first translated using any suitable translation service.

In some cases, before the clustering, the user experience data items are labeled as informative or non-informative. For example, a user experience data item can be considered informative if the user experience data item describes a problem.

The missed target score metric service can generate (420) a missed target score metric between the overall observed average score and the predetermined target score. In some cases, the missed target score metric service can generate (420) the missed target score metric using single factor decomposition. In some cases, the missed target score metric service can generate (420) the missed target score metric using two factor decomposition.

In the case of the two factor decomposition, the missed target score metric can indicate an affect corresponding factor values of a second factor of the determined factors have on an individual missed target score of each corresponding factor value of a first factor of the determined factors.

In some cases, generating the missed target score metric can include determining a total individual missed target score for the corresponding factor value of the first factor; and decomposing the total individual missed target score based on corresponding second factor values of the second factor.

In some cases, determining the total individual missed target score for the corresponding factor value of the first factor includes determining a difference between an individual average score for the corresponding factor value of the first factor and the target score.

In some cases, decomposing the total missed target score based on the corresponding second factor values of the second factor includes, for each corresponding second factor value of the second factor, determining, from the user experience data, a set of user experience data items having the corresponding factor value as the first factor and the corresponding second factor value as the second factor; determining a number of the user experience data items in the set of user experience data items having the corresponding factor value as the first factor and the corresponding second factor value as the second factor; and determining a total observed score for the user experience data items in the set of user experience data items having the factor value as the first factor and the corresponding second factor value as the second factor.

In some cases, decomposing the individual missed target score based on corresponding second factor values of the second factor further includes, for each corresponding second factor value of the second factor, determining an individual missed target score by determining a weighted difference between an observed average score for user experience data items in the set of user experience data items having the corresponding factor value as the first factor and the corresponding second factor value as the second factor and the target score. The total individual missed target score is a sum of the individual missed target scores for each corresponding second factor value.

In the case of the single factor decomposition, the missed target score metric can indicate an affect each corresponding factor value of the first factor of the determined factors has on the overall observed average score.

In some cases, generating the missed target score metric can include determining a total missed target score for the first factor; and decomposing the total missed target score for the first factor based on the corresponding factor values of the first factor. In some cases, determining the total missed target score for the first factor includes determining a difference between an individual average score for the first factor and the target score.

In some cases, decomposing the total missed target score for the first factor based on the corresponding factor values of the first factor includes, for each corresponding factor value of the first factor, determining, from the user experience data, a set of user experience data items having the corresponding factor value as the first factor; determining a number of the user experience data items in the set of user experience data items having the corresponding factor value as the first factor; and determining a total observed score for the user experience data items in the set of user experience data items having the corresponding factor value as the first factor.

In some cases, decomposing the total missed target score for the first factor based on the corresponding factor values of the first factor further includes, for each corresponding factor value of the first factor, determining an individual missed target score by determining a weighted difference between the individual average score for user experience data items in the set of user experience data items having the corresponding factor value as the first factor and the target score. The total missed target score for the first factor is a sum of the individual missed target scores for each corresponding factor value of the first factor.

The individual missed target score for each corresponding factor value of the first factor generated using the single factor decomposition can then be further decomposed using the two factor decomposition. Indeed, the missed target score metric generated using two factor decomposition can indicate an affect corresponding factor values of a second factor of the determined factors have on the individual missed target score of each corresponding factor value of a first factor, where the individual missed target score was determined using the single factor decomposition.

As an illustrative example of generating (420) a missed target score metric between an overall observed average score and a predetermined target score, a set of reviews, each described by a set of factors and corresponding factor values has an observed average score of 4.3, and an OKR which states that the average rating in an app store should be 4.5. A user can select one of these factors and determine the ranked list of distinct factor values of the selected factor that pull the average rating up and down. For example, if the selected factor is the review's language, net contribution of each language to pulling the average score up and down can be determined, and then, a list of ranked languages that need investigation can be generated.

In the illustrative example, Tₛ is the Target Score and Aₛ is the current Average Score. Here, Tₛ=4.5 and Aₛ=4.3. The Missed Target Score (MTS) is the difference between the current Average Score and the Target Score:

MTS=Aₛ−Tₛ (1)

In the illustrative example, X^{n×m}=[x₁^{m}, . . . xₙ^{m}] is the set of n reviews, each described by m factors; Sⁿ=[s₁, . . . , sₙ] is the list of associated scores each review has; and F^{m}=[f₁^{k}^{₁}, . . . , fₘ^{k}^{ₘ}] is the set of all possible factors and their associated factor values.

In the illustrative example, given any of the factors fᵢ^{k}^{ᵢ}=[f_{i,1}, . . . , f_{i,k}_{ᵢ}] for which the kᵢ distinct values are sorted alphabetically by default, a permutation that ranks the kᵢ distinct values based on their net contribution to the total MTS can be determined using single factor decomposition.

In the illustrative example, to generate a ranked list of factor values for a given factor fᵢ with kᵢ distinct factor values, a contribution of each factor value to the total MTS is determined. Before the contribution of each factor value to the total MTS is determined, additional entities are defined. The set of review indices that have f_{i,j} as the i^{th} factor is defined as:

i_{f}_{_{i,j}}={v|x_{v,i}=f_{i,j},v=1:n}

The number of reviews that have f_{i,j} as the i^{th} factor is defined as:

n_{f}_{_{i,j}}=|i_{f}_{_{i,j}}|

The total score for the reviews that have f_{i,j} as the i^{th} factor is defined as:

r_{f}_{_{i,j}}=Σ_{Vϵi}_{_{fi,j}}sᵥ

As an example, if fᵢ is the review's language and f_{i,j} is Spanish, then i_{f}_{_{i,j}} represents the set of review indices that have the review text written in Spanish, n_{f}_{_{i,j}} represents the number of reviews written in Spanish, and r_{f}_{_{i,j}} represents their total rating.

In the illustrative example, the total MTS decomposes based on all the values a given factor fᵢ^{k}^{ᵢ} can have using the following formulas:

$$\begin{matrix}MTS & = & {A}_{s} - {T}_{s} & \\ & = & \frac{1}{n} {\sum }_{i = 1}^{n} {s}_{i} - {T}_{s} & \\ & = & \frac{{\sum }_{i = 1}^{n} {s}_{i} - n \times {T}_{s}}{n} & \\ & = & \frac{{\sum }_{i = 1}^{n} {s}_{i} - {\sum }_{i = 1}^{n} {T}_{s}}{n} & \\ & = & \frac{{\sum }_{j}^{{k}_{i}} [ {r}_{{f}_{i , j}} - {n}_{{f}_{i , j}} \times {T}_{s} ]}{n} & \\ & = & {\sum }_{j}^{{k}_{i}} \frac{{n}_{{f}_{i , j}}}{n} \times [ \frac{{r}_{{f}_{i , j}}}{{n}_{{f}_{i , j}}} - {T}_{s} ] & \\ & = & {\sum }_{j}^{{k}_{i}} p ( {f}_{i , j} ) \times [ {A}_{s} ( {f}_{i , j} ) - {T}_{s} ] & ( 2 ) \\ & = & {\sum }_{i}^{{k}_{i}} mts ( {f}_{i , j} ) & ( 3 )\end{matrix}$$

In the illustrative example, equations (2) and (3) show that the total MTS is the sum of the kᵢ individual mts(f_{i,j}) values the given factor fᵢ^{k}^{ᵢ} can have and that each individual mts(f_{i,j}) is the weighted difference between the average score and the target score Tₛ, where the weight is the probability with which each factor value f_{i,j} occurs. Continuing with the above example, where fᵢ^{k}^{ᵢ} is the review's language, equation (3) shows that the total MTS can be decomposed based on all the languages in which reviews were received. Therefore, if the software developer is interested in the Spanish written reviews, the net contribution of the Spanish written reviews to MTS can be calculated using equation (2) where j is the index for the Spanish language.

In the illustrative example, the list of individual mts(f_{i,j}) values can be sorted to generate the ranked list of values for the given factor fᵢ^{k}^{ᵢ} described as by the permutation:

$$σ = ( \begin{matrix}1 & 2 & … & {k}_{i} \\ {j}_{1} & {j}_{2} & … & {j}_{{k}_{i}}\end{matrix} ) \qquad ( 4 )$$

such that mts(f_{i,σ}_{ᵢ}_{^{−(1)}})<= . . . <=mts(f_{i,σ}_{ᵢ}_{^{−1}}₍ₖ_{ᵢ}₎).

Continuing with the illustrative example, the missed target score metric service can generate (420) a missed target score metric between the overall observed average score and the predetermined target score by performing missed target score two factor decomposition. That is, a calculation of how the factor values of a first factor fᵢ^{k}^{ᵢ} are pulling the average score up and down in the context of a second factor fₚ^{k}^{ₚ} is performed.

While the missed target score single factor decomposition provides an understanding of how the factor values of a given factor are pulling the average score up and down, the missed target score two factor decomposition can provide a more in-depth exploration of a given factor. For example, using missed target score metrics generated with the missed target score two factor decomposition, a software developer can visualize when users started talking about a certain topic and for how long they kept talking about that topic, or which topic clusters are activating for different languages, or if there is a topic cluster that is activating only for a given manufacturer. Being able to answer these types of questions can deepen the understanding of user pain points and how to best address them.

In the illustrative example, for the missed target score two factor decomposition, a total MTS(f_{i,j}) for each kᵢ distinct values of the first factor fᵢ^{k}^{ᵢ} can be defined as:

$$\begin{matrix}MTS ( {f}_{i , j} ) & = & A ( {f}_{i , j} ) - {T}_{s} & \\ & = & \frac{{r}_{{f}_{i , j}}}{{n}_{{f}_{i , j}}} - {T}_{s} , j = 1 : {k}_{i} & ( 5 )\end{matrix}$$

where n_{f}_{_{i,j}} and r_{f}_{_{i,j}} are the number of reviews that have the i^{th} factor value equal to f_{i,j} and r_{f}_{_{i,j}} is their total score.

Each of the MTS(f_{i,j}) values can be decomposed based on the kₚ distinct values of the second factor fₚ^{k}^{ₚ}. To decompose each of the MTS(f_{i,j}) values, additional entities are defined. The set of review indices that have f_{i,j} as the i^{th} factor value and f_{p,q} as the p^{th} factor value can be defined as:

i_{f}_{_{i,j}}_{,f}_{_{p,q}}={v|x_{v,i}=f_{i,j} and x_{v,p}|=f_{p,q},v=1:n}

The number of reviews that have f_{i,j} as the i^{th} factor value and f_{p,q} as the p^{th} factor value can be defined as:

n_{f}_{_{i,j}}_{,f}_{_{p,q}}=|i_{f}_{_{i,j}}_{,f}_{_{p,q}}|

The total score for the reviews that have f_{i,j} as the i^{th} factor value and f_{p,q} as the p^{th} factor value can be defined as:

r_{f}_{_{i,j}}_{,f}_{_{p,q}}=Σ_{Vϵif}_{_{i,j}}_{,f}_{_{p,q}}sᵥ

Expanding on our previous example, if the single factor decomposition for the review's language showed that Spanish is the first biggest language that pulls the total MTS down, to further understand what the problem is, the total MTS(f_{i,j}) value can be decomposed based on all topic clusters f_{p,q}. Then, i_{f}_{_{i,j}}_{,f}_{_{p,q}} are all the review indices for which the review text was written in Spanish and have as cluster topic one of the k p distinct topics, (e.g., f_{p,q}=login button, i_{f}_{_{i,j}}_{,f}_{_{p,q}} is the total number of reviews, and r_{f}_{_{i,j}}_{,f}_{_{p,q}} is the total score).

Now let's see how each MTS(f_{i,j}) value decomposes based on all possible values of the second factor fₚ^{k}^{ₚ}:

$$\begin{matrix}MTS & = & A ( {f}_{i , j} ) - {T}_{s} & \\ & = & \frac{{r}_{{f}_{i , j}}}{{n}_{{f}_{i , j}}} - {T}_{s} & \\ & = & \frac{{r}_{{f}_{i , j}} - {n}_{{f}_{i , j}} \times {T}_{s}}{{n}_{{f}_{i , j}}} & \\ & = & \frac{{\sum }_{q}^{{k}_{p}} {r}_{{f}_{i , j} , {f}_{p , q}} - {n}_{{f}_{i , j} , {f}_{p , q}} \times {T}_{s}}{{n}_{{f}_{i , j}}} & \\ & = & {\sum }_{q}^{{k}_{p}} \frac{{n}_{{f}_{i , j} , {f}_{p , q}}}{{n}_{{f}_{i , j}}} \times [ \frac{{r}_{{f}_{i , j} , {f}_{p , q}}}{{n}_{{f}_{i , j} , {f}_{p , q}}} - {T}_{s} ] & \\ & = & {\sum }_{q}^{{k}_{p}} p ( {f}_{p , q} \vert {f}_{i , j} ) \times [ {A}_{s} ( {f}_{i , j} , {f}_{p , q} ) - {T}_{s} ] & ( 6 ) \\ & = & {\sum }_{q}^{{k}_{p}} mts ( {f}_{i , j} , {f}_{p , q} ) & ( 7 )\end{matrix}$$

Similarly, as for the single value decomposition of the total MTS, (6) and (7), show that the total MTS(f_{i,j}) of a given factor value f_{i,j} is just the sum of the k p distinct values the second factor has and that the individual mts(f_{i,j}, f_{p,q}) is the weighted difference between the average score for the two factor values and the target score. The individual mts(f_{i,j}, f_{p,q}) values can be sorted and a ranked list of the kₚ distinct values fₚ^{k}^{ₚ} has, in the context of f_{i,j} can be generated, as described by the permutation:

$${σ}_{p} = ( \begin{matrix}1 & 2 & … & {k}_{p} \\ {j}_{1} & {j}_{2} & … & {j}_{{k}_{p}}\end{matrix} ) \qquad ( 8 )$$

such that mts(f_{i,j}, f_{p,σ}_{ₚ}_{^{−1}}₍₁₎)<= . . . <=mts(f_{i,j}, f_{p,σ}_{ₚ}_{^{−1}}₍ₖ_{ₚ}₎).

The missed target score metric service can generate (425) a data visualization of the missed target score metric. The missed target score metric service can provide (430) the generated data visualization of the missed target score metric.

In some cases, generating the data visualization of the missed target score metric includes sorting the individual missed target score for each corresponding second factor value to generate a ranked list of corresponding second factor values of the second factor in the context of the corresponding factor value of the first factor. In this case, the ranked list is the generated data visualization of the missed target score metric.

In some cases, generating the data visualization of the missed target score metric includes mapping the individual missed target score for each corresponding second factor value to a missed target score level indicating a direction from the target score and a magnitude of the individual missed target score.

The generated data visualization of the missed target score metric can be provided to a dashboard. The dashboard can allow different stakeholders to visualize the results of the missed target score metric. Advantageously, the data visualization of the missed target score metric can reveal underlying issues with a software application or computing system, as well as show a level of pain for each of those issues.

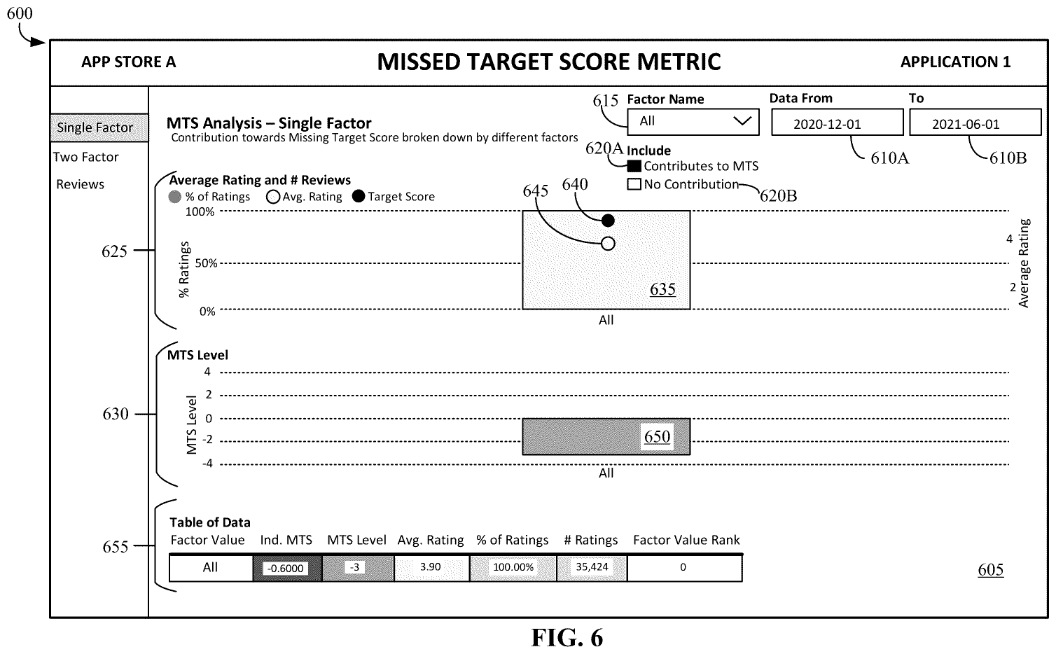

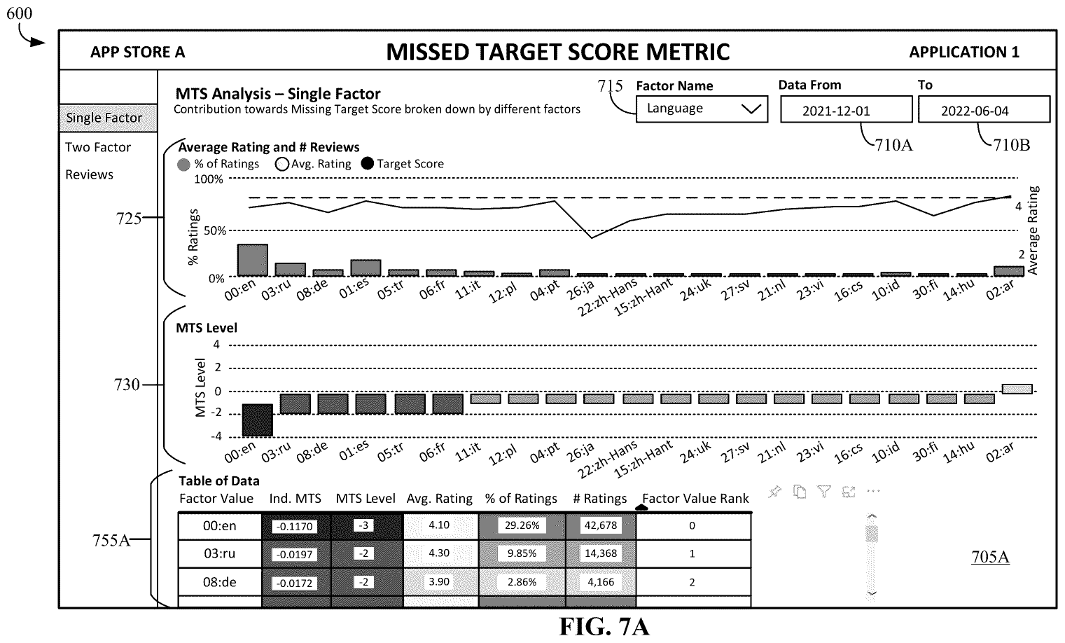

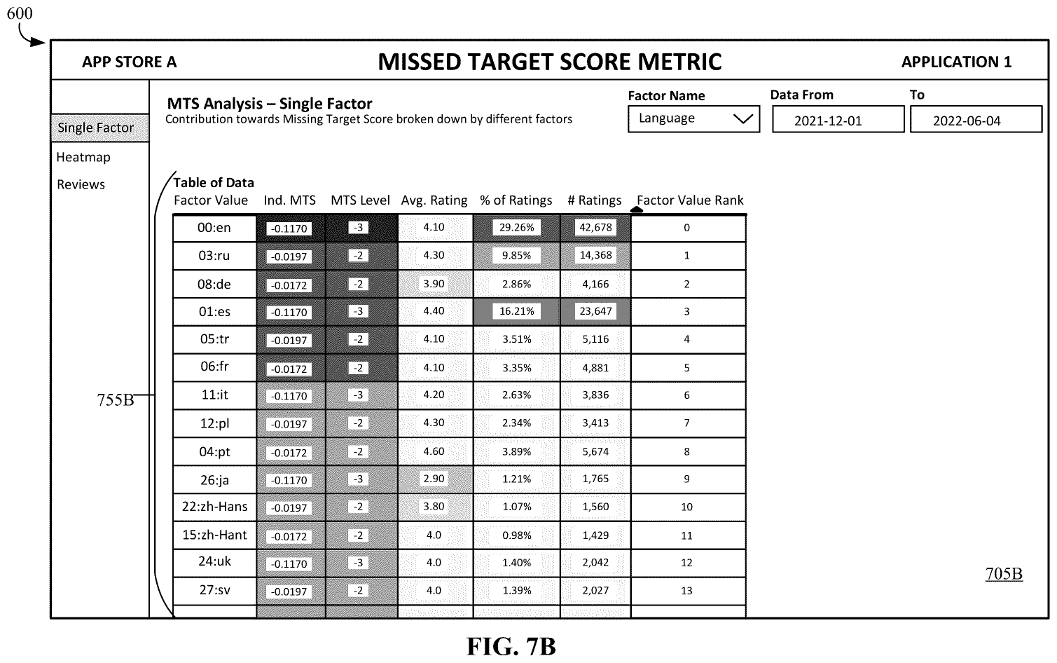

An example dashboard can include a single factor view where a set of predefined factors are available for exploration through single factor decomposition. Using the single factor view of the dashboard, any stakeholder can immediately understand which topic clusters, or which review language, or which manufacturer are pulling the total average score up and down. An example of a single factor view is provided in FIG. 6 and FIGS. 7A and 7B.

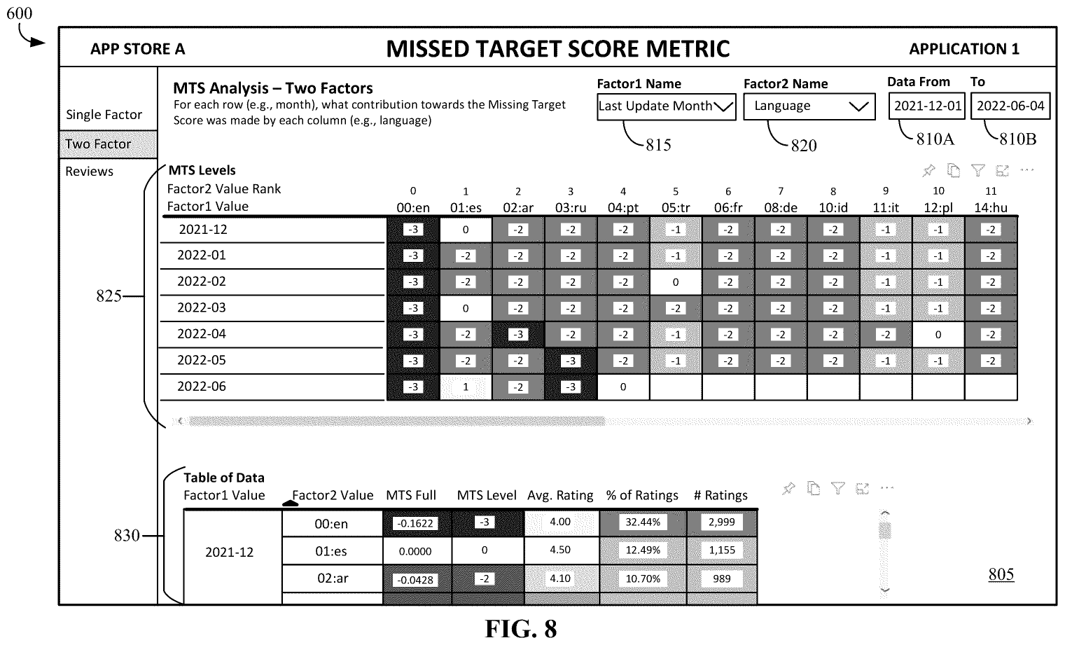

The example dashboard can also include a two factor view where a set of predefined factors can be explored in the context of another factor using two factor decomposition. Using the two factor view of the dashboard, any stakeholder can immediately understand which topic clusters are pulling the monthly average score up or down, or which manufacturer is pulling each topic cluster's average score up and down. An example of a two factor view is provided in FIG. 8.

The example dashboard can also include a reviews view where a subset of the reviews can be sliced using few predefined filters. This can allow for an in-depth understanding of what users are saying. Indeed, the reviews view allows for a deep dive into what the users are actually saying. For example, a software developer can choose to look at one topic cluster, and, using a set of filters, can further narrow down a selection if they want to see only reviews written in a given language or with a given rating.

In some cases, the reviews view includes a wordcloud display. For a quick understanding of what a topic cluster is about, the wordcloud displays the top dominant keywords extracted from the reviews that were clustered together.

Advantageously, after exploring the single factor view and the two factor view, a stakeholder can be provided an in depth understanding of the most critical user pain points by answering questions like: What exactly are the user saying about topic X when they are writing in language Y using devices from manufacturer Z?

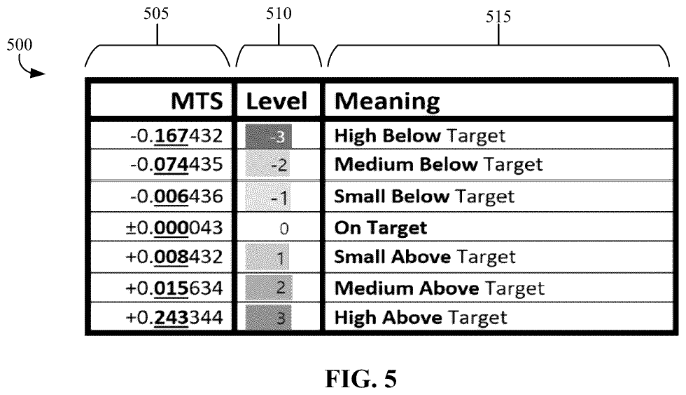

FIG. 5 illustrates an example data visualization of missed target score metrics according to certain embodiments of the invention. Referring to FIG. 5, data visualization 500 can provide an interpretation of a missed target score metric through missed target score levels.

As previously described, a missed target score metric can include real numbers. For example, each factor value of a given factor can have an individual missed target score. Each individual missed target score can be assigned a missed target score level. In some cases, each level is assigned a color. The missed target score level can be presented, for example, on a dashboard, and can provide an immediate understanding of where the problems are within a software application and where things are going well within the application. Advantageously, the missed target score level can reveal underlying issues with the application and/or computing system that otherwise may not be discovered.

Each individual missed target score can be assigned a level by encoding a direction and magnitude of the individual missed target score value. That is, each individual missed target score for each corresponding factor value can be mapped to a missed target score level indicating a direction from the target score and a magnitude of the individual missed target score.

The following formula can be used when assigning a missed target score level:

$$L ( x ) = \{ \begin{matrix}sign ( x ) \times ⌊ {log}_{10} ( \vert x \vert \times {10}^{{n}_{L}} ) + 1 ⌋ , & if \vert x \vert \times {10}^{{n}_{L}} > 0 \\ 0 , & otherwise\end{matrix}$$

For example, if we denote by n_{L} three levels of magnitude, (low, medium and high), and two directions, (below and above), any missed target score real value can be mapped to a level.

In the illustrative example, data visualization 500 shows the missed target score 505, a corresponding level 510, and a meaning 515. Advantageously, the missed target score level and corresponding level color can allow a software developer to visualize the level of pain related to the missed target score for each factor value.

FIG. 6 illustrates a snapshot of an example graphical user interface displaying a data visualization of a missed target score metric according to an embodiment of the invention; and FIGS. 7A and 7B illustrate snapshots of an example graphical user interface displaying data visualizations of a missed target score metric according to an embodiment of the invention.

Referring to FIG. 6 and FIGS. 7A and 7B, a user may open a missed target score metric dashboard 600 for an application (e.g., Application 1) on their computing device. The computing device may be any computing device such as, but not limited to, a personal computer, a reader, a mobile device, a personal digital assistant, a wearable computer, a smart phone, a tablet, a laptop computer (notebook or netbook), a gaming device or console, an entertainment device, a hybrid computer, a desktop computer, a smart television, or an electronic whiteboard or large form-factor touchscreen.

Through the dashboard 600, the user can select a single factor view (e.g., view 605 shown in FIG. 6 and view 705A shown in FIG. 7A, and view 705B shown in FIG. 7B) of a missed target score metric for application 1. Through the single factor view, a set of predefined factors are available for exploration. That is, the single factor view allows a user to select a factor and show the overall picture of the stressors and delighters for the selected factor. The single factor view can provide a ranked list of all the distinct factor values a selected factor has.

For example, a user can determine which aspects or topics user are happy with or unhappy with when using an application by selecting “topic cluster” as the factor to explore. As another example, the user can determine which languages users are writing in when they write a review discussing an issue with the application by selecting “language” as the factor to explore. In this example, the user might discover that users in a certain country are having issues with the application. Advantageously, using the single factor view of the dashboard 600, any stakeholder can immediately understand which topic clusters, or which review language, or which manufacturer are pulling the total average score up and down.

In the illustrative example of FIG. 6 and FIGS. 7A and 7B, the user experience data used to generate the missed target score metric includes ratings and reviews of Application 1 received from App Store A.

Within the single factor view, the user can define a period for which the ratings and reviews are received through date input fields (e.g., “From” date input field 610A and “To” date input field 610B shown in FIG. 6 and “From” date input field 710A and “To” date input field 710B shown in FIG. 7A) in the upper right corner of the single factor view.

The user can select different factors to explore using a factor name drop-down list (e.g., factor name drop-down list 615 shown in FIG. 6 and factor name drop-down list 715 shown in FIG. 7A). Using two check boxes (e.g., “Contributes to MTS” box 620A and “No Contribution” box 620B shown in FIG. 6), the user can choose to visualize only factor values that are below and above the target, only factor values that are on target, or all factor values of the factor selected in the factor name drop-down list.

The single factor view includes two graphs, a first graph (e.g., Average Rating and #Reviews graph 625 shown in FIG. 6 and Average Rating and #Reviews graph 725 shown in FIG. 7A) and a second graph (e.g., MTS level graph 630 shown in FIG. 6 and MTS level graph 730 shown in FIG. 7A), to help visualize the data. The x-axis for both graphs show a ranked list of factor values for the selected factor. The first graph shows the percentage of ratings (e.g., percentage 635 shown in FIG. 6) for each factor value, an observed average score (e.g., observed average rating 645) for each factor value, and a target score (e.g., target score 640 shown in FIG. 6) for each factor value. The second graph shows an MTS level (e.g., MTS level 650 shown in FIG. 6) for each factor value.

The single factor view includes a table of data (e.g., table 655 shown in FIG. 6 and table 755A shown in FIG. 7A and table 755B shown in FIG. 7B) for further exploration of the distinct factor values a selected factor has. The table includes data for each of “Factor Value”, “Ind. MTS”, “MTS Level”, “Avg. Rating”, “% of Ratings”, “# of Ratings”, and “Factor Value Rank”.

Referring to FIG. 6, the user has selected ‘All’ for the factor in the factor name drop-down list 615 and input ‘2020-12-01’ for the “From” date input field 610A and ‘2021-06-01’ for the “To” date input field 610B. Selecting to view all of the factors provides the user with information on all reviews during the six-month observation period from Dec. 1, 2020 to Jun. 1, 2021.

As can be seen, Application 1 received 35,424 reviews in App Store A. The observed average rating 645 is 3.9, the target score 640 is 4.5, and the percentage 635 that the reviews represent is 100%. Here, the MTS level 650 is minus 3, because the observed average rating 645 is missing the target score 640 by −0.6.

Referring to FIG. 7A, the user has selected ‘Language’ for the factor in the factor name drop-down list 715 and input ‘2021-12-01’ for the “From” date input field 710A and ‘2022-06-04’ for the “To” date input field 710B.

In the illustrative example, the factor values for the selected factor ‘Language’ include ‘00:en’, ‘03:ru’, ‘08:de’, ‘01:es’, ‘05:tr’, ‘06:fr’, ‘11:it’, ‘12:pl’, ‘26:ja’, ‘22:zh-Hans’, ‘15:zh-Hant’, ‘24:uk’, ‘27:sv’, ‘21:nl’, ‘23:vi’, ‘16:cs’, ‘10:id’, ‘30:fi’, ‘14:hu’, and ‘02:ar’. As can be seen in the Average Rating and #Reviews graph 725, the ‘00:en’ factor value has an observed average rating of 4.10, a target score of 4.5, and a percentage of ratings where English was the review language of 29.26%. Aₛ can be seen in the MTS Level graph 730, the MTS level for the factor value ‘00:en’ is −3. Here, the MTS level is −3 because the observed average rating the factor value ‘00:en’ is missing the target score by −0.117.

Table 755A includes additional information, including “Factor Value”, “Ind. MTS”, “MTS Level”, “Avg. Rating”, “% of Ratings”, “# of Ratings”, and “Factor Value Rank” for each of the factor values for the selected factor ‘Language’. Here, the table 755A is sorted by “Factor Value Rank” and data for three factor values (‘00:en’, ‘03:ru’, ‘08:de’) are shown.

Referring to FIG. 7B, the user can explore the distinct factor values a selected factor has through table 755B, which is an expanded view of table 755A shown in FIG. 7A. Table 755B includes additional information, including “Factor Value”, “Ind. MTS”, “MTS Level”, “Avg. Rating”, “% of Ratings”, “# of Ratings”, and “Factor Value Rank” for each of the factor values for the selected factor ‘Language’. Here, the table 755B is sorted by “Factor Value Rank” and data for fourteen factor values (‘00:en’, ‘03:ru’, ‘08:de’, ‘01:es’, ‘05:tr’, ‘06:fr’, ‘12:pl’, ‘26:ja’, ‘22:zh-Hans’, ‘15:zh-Hant’, ‘24:uk’, ‘27:sv’) are shown.

FIG. 8 illustrates a snapshot of an example graphical user interface displaying a data visualization of a missed target score metric according to an embodiment of the invention. Referring to FIG. 8, through the dashboard 600, the user can select a two-factor view (e.g., view 805) of a missed target score metric for application 1.

Expanding on the single factor view, the two-factor view lets a user further break down user experience data. Through the two-factor view, a set of predefined factors can be explored in the context of another factor using two factor decomposition. Indeed, the two-factor view illustrates how two factors interact with each other. For example, a user can explore a problem with an application in the context of months or application releases to see when the problem began and if the problem still exists. Here, the user can see that one topic had a problem in January, but in the current month the problem has been fixed. Advantageously, using the two-factor view of the dashboard 600, any stakeholder can immediately understand which topic clusters are pulling the monthly average score up or down or which manufacturer is pulling each topic cluster's average score up and down.

Similar to FIG. 6 and FIGS. 7A and 7B, in the illustrative example of FIG. 8, the user experience data used to generate the missed target score metric includes ratings and reviews of Application 1 received from App Store A.

Within the two-factor view, the user can define a period for which the ratings and reviews are received through date input fields (e.g., “From” date input field 810A and “To” date input field 810B) in the upper right corner of the single factor view. A factor1 name drop-down list 815 offers a set of factors for which their total missed target score can be further decomposed based on the factor values of a factor selected in a factor2 name drop-down list 820.

The two-factor view includes two tables, an MTS levels table (e.g., The MTS levels table 825) and a table of data (e.g., table 830). The MTS levels table illustrates, for each row, what contribution towards the missing target score was made by each column. The table of data allows for further exploration of the distinct factor values factor1 has in the context of the factor values of factor2. The table includes data for each of “Factor1 Value”, “Factor2 Value”, “MTS Full”, “MTS Level”, “Avg. Rating”, “% of Ratings”, “# of Ratings”.

In the illustrative example of FIG. 8, the user has selected ‘Month’ for the factor in the factor1 name drop-down list 815 and ‘Language’ for the factor in the factor2 name drop-down list 820. The user has input ‘2021-12-01’ for the “From” date input field 810A and ‘2022-06-04’ for the “To” date input field 810B. Here, the MTS levels table 825 illustrates, for each month, what contribution towards the missing target score was made by each language. Thus, through the two-factor view 805, the user can identify which languages are pulling the monthly average score up or down for each month during the six-month observation period from Dec. 1, 2021 to Jun. 4, 2022.

### Additional Example Scenario

As an additional example scenario, missed target score metrics can be generated with Net Promoter Score® (NPS) as the base metric using the following equations:

$$\begin{matrix}{MTS}_{NPS} = NPS - {T}_{s} \\ = \frac{D - P}{n} - {T}_{s} \\ = \frac{1}{n} {\sum }_{i = 1}^{k} ( {d}_{i} - {p}_{i} ) - {T}_{s} \\ = \frac{{\sum }_{i = 1}^{k} ( {d}_{i} - {p}_{i} ) - n \times {T}_{s}}{n} \\ = \frac{{\sum }_{i = 1}^{k} ( {d}_{i} - {p}_{i} ) - {\sum }_{i = 1}^{n} {T}_{s}}{n} \\ = \frac{{\sum }_{i = 1}^{k} [ ( {d}_{i} - {p}_{i} ) - {n}_{i} \times {T}_{s} ]}{n} \\ = {\sum }_{i = 1}^{k} \frac{{n}_{i}}{n} \times [ \frac{{d}_{i} - {p}_{i}}{{n}_{i}} - {T}_{s} ] \\ = {\sum }_{i = 1}^{k} p ( i ) \times [ {NPS}_{i} - {T}_{s} ] \\ = {\sum }_{i = 1}^{k} {mts}_{NPS} ( i )\end{matrix}$$

where:
NPS—total NPS.
Tₛ—Target Score.
D—number of Detractors.
P—number of Promoters.
n—total number of reviews.
k—the number of distinct values a factor can have. For example, if the factor is the review's language, k represents the number of distinct languages in which reviews are written.
nᵢ—number of reviews for the i^{th} factor value, i.e. n=Σᵢ^{k} nᵢ.
pᵢ—number of promoters for the i^{th} factor value, i.e. P=Σᵢ^{k} pᵢ.
dᵢ—number of promoters for the i^{th} factor value, i.e. D=Σᵢ^{k} dᵢ.
p(i)—probability (percentage) of reviews for the i^{th} factor value, i.e. Σᵢ^{k} p(i)=1, e.g. how many reviews are written in English.
NPSᵢ—the NPS score for the i^{th} factor value.

As an additional example scenario, a partial missed target score metric can be generated. Performing missed target score decomposition for topic clusters is a step forward in prioritizing user pain points. But sometimes in a review, a user is talking about more than one topic by mentioning different keywords. Therefore, instead of assigning each review to a single topic cluster and performing missed target score single factor decomposition at cluster level, a review can be further decomposed based on the keywords that are mentioned. The missed target score decomposition can then be done at keywords level.

As an additional example scenario, a missed target tree score tree can be generated. In some cases, performing missed target score decomposition one factor at a time is a step forward when there is a hypothesis about which factors to investigate. With the missed target tree score tree, the missed target score decomposition can partition the entire factor space to uncover segments that have the worst user experience and those that have the best user experience. In this example scenario, when the stakeholders would open a missed target score metric dashboard, they will have available for exploration the ranked list of profiles (e.g., review language=‘Spanish’, month=‘2020-12’, manufacturer=‘Samsung’, keyword=‘login’) from the worst to the best experience.

FIG. 9 illustrates components of an example computing system that may be used to implement certain methods and services described herein. Referring to FIG. 9, system 950 may be implemented within a single computing device or distributed across multiple computing devices or sub-systems that cooperate in executing program instructions. Accordingly, more or fewer elements described with respect to system 950 may be incorporated to implement a particular system. The system 950 can include one or more blade server devices, standalone server devices, personal computers, routers, hubs, switches, bridges, firewall devices, intrusion detection devices, mainframe computers, network-attached storage devices, and other types of computing devices.

In embodiments where the system 950 includes multiple computing devices, the server can include one or more networks that facilitate communication among the computing devices. For example, the one or more networks can include a local or wide area network that facilitates communication among the computing devices. One or more direct communication links can be included between the computing devices. In addition, in some cases, the computing devices can be installed at geographically distributed locations. In other cases, the multiple computing devices can be installed at a single geographic location, such as a server farm or an office.

System 950 can include processing system 955 of one or more processors to transform or manipulate data according to the instructions of software 960 stored on a storage system 965. Examples of processors of the processing system 955 include general purpose central processing units (CPUs), graphics processing units (GPUs), field programmable gate arrays (FPGAs), application specific processors, and logic devices, as well as any other type of processing device, combinations, or variations thereof.

Software 960 can include an operating system, applications, and services, such as missed target score metric service 970; and missed target score metric service 970 may perform some or all of process 400 as described with respect to FIG. 4.

Storage system 965 may comprise any suitable computer readable storage media. Storage system 965 may include volatile and nonvolatile memories, removable and non-removable media implemented in any method or technology for storage of information, such as computer readable instructions, data structures, program modules, or other data. Examples of storage media of storage system 965 include random access memory, read only memory, magnetic disks, optical disks, CDs, DVDs, flash memory, magnetic cassettes, magnetic tape, magnetic disk storage or other magnetic storage devices, or any other suitable storage media. In no case do storage media consist of transitory, propagating signals.

Storage system 965 may be implemented as a single storage device but may also be implemented across multiple storage devices or sub-systems co-located or distributed relative to each other. Storage system 965 may include additional elements, such as a controller, capable of communicating with processing system 955.

Network/communication interface 985 may include communications connections and devices that allow for communication with other computing systems over one or more communication networks (not shown). Examples of connections and devices that together allow for inter-system communication may include network interface cards, antennas, power amplifiers, RF circuitry, transceivers, and other communication circuitry. The connections and devices may communicate over communication media (such as metal, glass, air, or any other suitable communication media) to exchange communications with other computing systems or networks of systems. Transmissions to and from the communications interface are controlled by the OS, which informs applications of communications events when necessary.

Alternatively, or in addition, the functionality, methods and processes described herein can be implemented, at least in part, by one or more hardware modules (or logic components). For example, the hardware modules can include, but are not limited to, application-specific integrated circuit (ASIC) chips, field programmable gate arrays (FPGAs), system-on-a-chip (SoC) systems, complex programmable logic devices (CPLDs) and other programmable logic devices now known or later developed. When the hardware modules are activated, the hardware modules perform the functionality, methods and processes included within the hardware modules.

Certain embodiments may be implemented as a computer process, a computing system, or as an article of manufacture, such as a computer program product or computer-readable storage medium. Certain methods and processes described herein can be embodied as software, code and/or data, which may be stored on one or more storage media. Certain embodiments of the invention contemplate the use of a machine in the form of a computer system within which a set of instructions, when executed by hardware of the computer system (e.g., a processor or processing system), can cause the system to perform any one or more of the methodologies discussed above. Certain computer program products may be one or more computer-readable storage media readable by a computer system (and executable by a processing system) and encoding a computer program of instructions for executing a computer process. It should be understood that as used herein, in no case do the terms “storage media”, “computer-readable storage media” or “computer-readable storage medium” consist of transitory carrier waves or propagating signals.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

What is claimed is:

1. A method comprising:
obtaining, at a computing system, user experience data of an application comprising an overall observed average score of the application from user feedback data and any text associated with the user feedback data;
obtaining, at the computing system, a predetermined target score for the application;
analyzing, at the computing system, the user experience data to determine factors and corresponding factor values, each factor being an individual attribute of the user experience data, the determined factors comprising a first factor;
generating, by the computing system, a missed target score metric between the overall observed average score and the predetermined target score indicating an affect corresponding factor values of a second factor of the determined factors have on an individual missed target score for a corresponding factor value of the first factor of the determined factors;
generating, by the computing system, a data visualization of the missed target score metric; and
providing, by the computing system, the generated data visualization of the missed target score metric.

2. The method of claim 1, wherein generating, via the computing system, the missed target score metric comprises:
determining a total individual missed target score for the corresponding factor value of the first factor, wherein determining the total individual missed target score for the corresponding factor value of the first factor comprises determining a weighted difference between the individual average score for the corresponding factor value of the first factor and the predetermined target score; and
decomposing the total individual missed target score based on the corresponding second factor values of the second factor.

3. The method of claim 2, wherein decomposing the total individual missed target score based on the corresponding second factor values of the second factor comprises:
for each corresponding second factor value of the second factor, determining an individual missed target score by determining a weighted difference between an individual average score for user experience data items in a set of user experience data items having the corresponding factor value as the first factor and the corresponding second factor value as the second factor and the predetermined target score,
wherein the total individual missed target score is a sum of the individual missed target score for each corresponding second factor value.

4. The method of claim 3, wherein decomposing the total individual missed target score based on the corresponding second factor values of the second factor further comprises:
for each corresponding second factor value of the second factor:
determining, from the user experience data, the set of user experience data items having the corresponding factor value as the first factor and the corresponding second factor value as the second factor;
determining a number of the user experience data items in the set of user experience data items having the corresponding factor value as the first factor and the corresponding second factor value as the second factor; and
determining a total observed score for the user experience data items in the set of user experience data items having the factor value as the first factor and the corresponding second factor value as the second factor.

5. The method of claim 3, wherein generating the data visualization of the missed target score metric comprises sorting the individual missed target score for each corresponding second factor value to generate a ranked list of corresponding second factor values of the second factor in a context of the corresponding factor value of the first factor, the ranked list being the generated data visualization of the missed target score metric.

6. The method of claim 3, wherein generating the data visualization of the missed target score metric comprises mapping the individual missed target score for each corresponding second factor value to a missed target score level indicating a direction from the predetermined target score and a magnitude of the individual missed target score.

7. The method of claim 1, further comprising:
generating, by the computing system, a second missed target score metric between the overall observed average score and the predetermined target score indicating an affect each corresponding factor value of the first factor of the determined factors has on the overall observed average score, wherein the second missed target score metric is the individual missed target score for the corresponding factor value of the first factor of the determined factors;
generating, by the computing system, a data visualization of the second missed target score metric; and
providing, by the computing system, the generated data visualization of the second missed target score metric.

8. The method of claim 1, wherein analyzing, at the computing system, the user experience data to determine factors and corresponding factor values comprises:
extracting keywords from the user experience data; and
inferring topic clusters from the text associated with the user feedback.

9. The method of claim 1, wherein the first factor of the determined factors is language and the corresponding first factor value is a distinct language.

10. A computer-readable storage medium having instructions stored thereon that, when executed by a processing system, perform a method comprising:
obtaining user experience data of an application comprising an overall observed average score of the application from user feedback data and any text associated with the user feedback data;
obtaining a predetermined target score for the application;
analyzing the user experience data to determine factors and corresponding factor values, each factor being an individual attribute of the user experience data, the determined factors comprising a first factor;
generating a missed target score metric between the overall observed average score and the predetermined target score indicating an affect corresponding factor values of a second factor of the determined factors have on an individual missed target score for a corresponding factor value of the first factor of the determined factors;
generating a data visualization of the missed target score metric; and
providing the generated data visualization of the missed target score metric.

11. The medium of claim 10, wherein generating the missed target score metric comprises:
determining a total individual missed target score for the corresponding factor value of the first factor, wherein determining the total individual missed target score for the corresponding factor value of the first factor comprises determining a weighted difference between the individual average score for the corresponding factor value of the first factor and the predetermined target score; and
decomposing the total individual missed target score based on the corresponding second factor values of the second factor.

12. The medium of claim 11, wherein decomposing the total individual missed target score based on the corresponding second factor values of the second factor comprises:
for each corresponding second factor value of the second factor:
determining, from the user experience data, a set of user experience data items having the corresponding factor value as the first factor and the corresponding second factor value as the second factor;
determining a number of the user experience data items in the set of user experience data items having the corresponding factor value as the first factor and the corresponding second factor value as the second factor;
determining a total observed score for the user experience data items in the set of user experience data items having the factor value as the first factor and the corresponding second factor value as the second factor; and
determining an individual missed target score by determining a weighted difference between an individual average score for user experience data items in the set of user experience data items having the corresponding factor value as the first factor and the corresponding second factor value as the second factor and the predetermined target score,
wherein the total individual missed target score is a sum of the individual missed target score for each corresponding second factor value.

13. The medium of claim 11, wherein generating the data visualization of the missed target score metric comprises sorting the individual missed target score for each corresponding second factor value to generate a ranked list of corresponding second factor values of the second factor in a context of the corresponding factor value of the first factor, the ranked list being the generated data visualization of the missed target score metric.

14. The medium of claim 10, wherein the method further comprises:
generating a second missed target score metric between the overall observed average score and the predetermined target score indicating an affect each corresponding factor value of the first factor of the determined factors has on the overall observed average score, wherein the second missed target score metric is the individual missed target score for the corresponding factor value of the first factor of the determined factors;
generating a data visualization of the second missed target score metric; and
providing the generated data visualization of the second missed target score metric.

15. The medium of claim 10, wherein analyzing the user experience data to determine factors and corresponding factor values comprises:
extracting keywords from the user experience data; and
inferring topic clusters from the text associated with the user feedback.

16. A system comprising:
a processing system;
a storage system; and
instructions stored on the storage system that, when executed by the processing system, direct the processing system to:
obtain user experience data of an application comprising an overall observed average score of the application from user feedback data and any text associated with the user feedback data;
obtain a predetermined target score for the application;
analyze the user experience data to determine factors and corresponding factor values, each factor being an individual attribute of the user experience data, the determined factors comprising a first factor;
generate a missed target score metric between the overall observed average score and the predetermined target score indicating an affect each corresponding factor value of the first factor of the determined factors has on the overall observed average score, wherein the missed target score metric is an individual missed target score for the corresponding factor value of the first factor of the determined factors;
generate a second missed target score metric between the overall observed average score and the predetermined target score indicating an affect corresponding factor values of a second factor of the determined factors have on the individual missed target score for a corresponding factor value of the first factor of the determined factors;
generate a data visualization of the missed target score metric and a data visualization of the second missed target score metric; and
provide the generated data visualization of the missed target score metric and the data visualization of the second missed target score metric.

17. The system of claim 16, wherein the instructions to generate the second missed target score metric further direct the processing system to:
determine a total individual missed target score for the corresponding factor value of the first factor; and
decompose the total individual missed target score based on the corresponding second factor values of the second factor.

18. The system of claim 17, wherein the instructions to determine the total individual missed target score for the corresponding factor value of the first factor direct the processing system to determine a weighted difference between the individual average score for the corresponding factor value of the first factor and the predetermined target score,
wherein the instructions to decompose the total individual missed target score based on the corresponding second factor values of the second factor direct the processing system to:
for each corresponding second factor value of the second factor:
determine, from the user experience data, a set of user experience data items having the corresponding factor value as the first factor and the corresponding second factor value as the second factor;
determine a number of the user experience data items in the set of user experience data items having the corresponding factor value as the first factor and the corresponding second factor value as the second factor;
determine a total observed score for the user experience data items in the set of user experience data items having the factor value as the first factor and the corresponding second factor value as the second factor; and
determine an individual missed target score by determining a weighted difference between an observed average score for user experience data items in the set of user experience data items having the corresponding factor value as the first factor and the corresponding second factor value as the second factor and the predetermined target score,
wherein the total individual missed target score is a sum of the individual missed target score for each corresponding second factor value.

19. The system of claim 17, wherein the instructions to generate the data visualization of the second missed target score metric direct the processing system to map the individual missed target score for each corresponding second factor value to a missed target score level indicating a direction from the predetermined target score and a magnitude of the individual missed target score.

20. The system of claim 16, wherein the instructions to analyze the user experience data to determine factors and corresponding factor values direct the processing system to:
extract keywords from the user experience data; and
infer topic clusters from the text associated with the user feedback.
